(19) United States
(12) Patent Application Publication
(10) Pub. No.: US 2010/0060056 A1
(43) Pub. Date: Mar. 11, 2010

(54) SAFETY DEVICE FOR A CHILD SEAT IN A VEHICLE

(75) Inventor: Martin Pos, Bayreuth (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Columbus Trading Partners GmbH, Kulmbach (DE)

(21) Appl. No.: 12/551,851

(22) Filed: Sep. 1, 2009

(30) Foreign Application Priority Data
Sep. 8, 2008 (DE) 10 2008 046 249.7

(51) Int. Cl. B60N 2/26

(52) U.S. Cl. 297/256.15

(57) ABSTRACT

Safety device for a child seat (10) in a vehicle, having a seat surface (12), backrest (13) and armrests (15), which comprises at least one catching element (16) which, extending approximately transversely above the thighs of a child sitting in the child seat, is mounted so as to be adjustable in the longitudinal direction of the armrests (15). The adjustment direction (18) of the catching element (16) runs at a predetermined angle (α), increasing from back to front, of preferably about from 5° to 20°, relative to the seat surface (12).

The present invention relates to a safety device for a child seat in a vehicle, having a seat surface, backrest and optionally armrests, which comprises at least one catching element which, extending approximately transversely above the thighs of a child sitting in the child seat, is mounted so as to be adjustable in a direction approximately parallel to the seat surface.

Such a safety device is known, for example, from DE 103 51 918 A1 or DE 198 55 032 C1. In the construction according to DE 103 51 918 A1, in the event of the vehicle's decelerating the catching element performs a movement directed towards the child. The safety potential for the child in the event of an accident is said thus to be increased, because in the event of substantial deceleration of the vehicle the movement or pitching motion of the child's body is further limited or avoided.

The construction according to DE 198 55 032 C1 is primarily concerned with increased comfort. The catching element has two foldable parts which make it easier for the child to get in and out. Furthermore, the catching element is mounted so as to be displaceable in the longitudinal direction of the armrests of the child seat for adjustment to the size of the child.

Adjustment to the size of the child can be achieved only inadequately, however, using that construction alone.

Accordingly, the present invention is based on the problem of providing a safety device for a child seat in a vehicle which, in addition to offering the required safety in the event of strong deceleration of the vehicle or in the event of an accident, also offers increased comfort for the child.

That problem is solved according to the invention by the characterizing features of claim 1, with advantageous details and developments being described in the subsidiary claims.

One aspect of the present invention therefore lies in the fact that the adjustment direction of the catching element runs at a predetermined angle, increasing from back to front, of greater than 0°, especially of about from 5° to 20°, relative to the seat surface. The catching element can thus be better adapted to the body size of the child both in the horizontal direction and in the vertical direction.

The catching element is preferably adjustable steplessly or alternatively stepwise. In the latter case, the catching element is preferably lockable at each adjustment step. Reference is made to claims 5 to 7 in respect of the construction of a suitable locking device.

In accordance with claim 10 a special safety element is proposed which can be used in combination with the above-mentioned invention but also independently thereof. Accordingly, the catching element is to comprise elements that are plastically deformable under the action of impact forces, which elements absorb and dissipate a large proportion of the impact energy. Those plastically deformable elements can be part of the longitudinal guide means of the catching element on the child seat. Alternatively, such plastically deformable elements can be provided in the region of the chest support or in the region of attachment of the catching element to the child seat.

A further aspect of the present invention is distinguished by the fact that the catching element serves simultaneously for receiving the safety belt associated with the motor vehicle, so that the child seat including the catching element is fixable to the vehicle seat. In that respect, the catching element fulfils a double function, that is to say
as a receiver for the safety belt associated with the motor vehicle, thus fixing the child seat to the vehicle seat;
as a holding element for the child in the seat adaptable to the size of the child.

A preferred embodiment of a safety device according to the present invention will be described in greater detail below with reference to the accompanying drawing, special mention also being made of further aspects of the present invention:

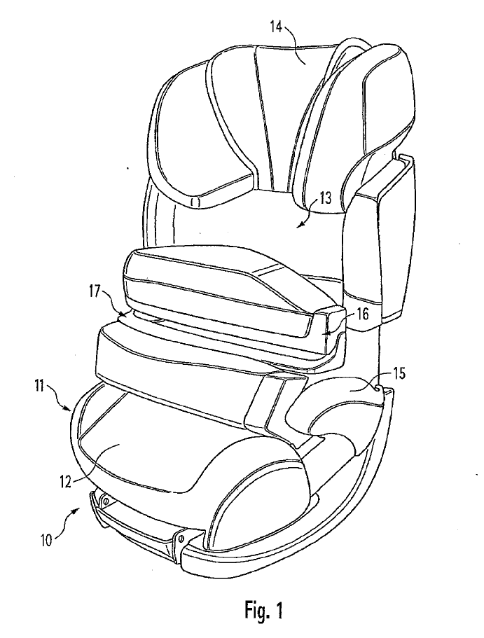

FIG. 1 is a perspective view of a child seat having a catching device;

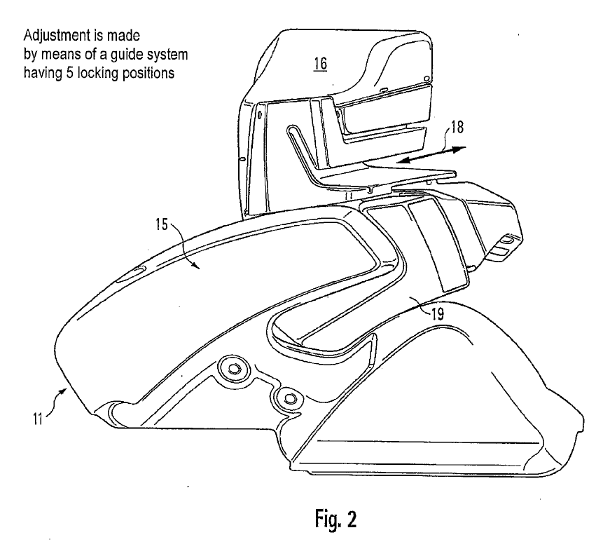

FIG. 2 shows the seat part of the child seat according to FIG. 1 without its padded covering and with the catching element constructed in accordance with the invention, in side view;

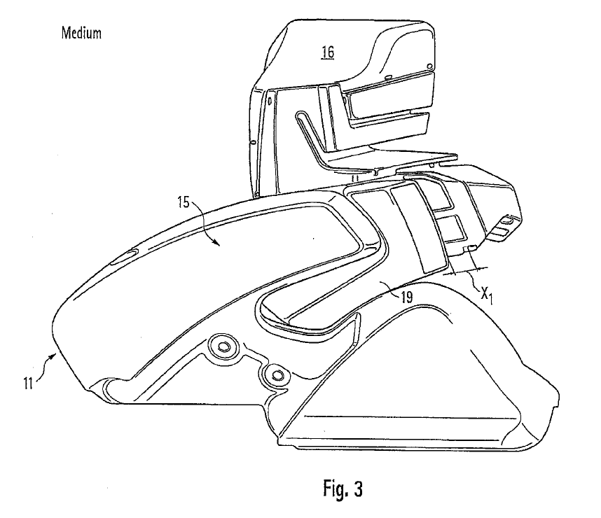

FIG. 3 is a view corresponding to FIG. 2, the catching element having been displaced slightly forwards/upwards (middle position);

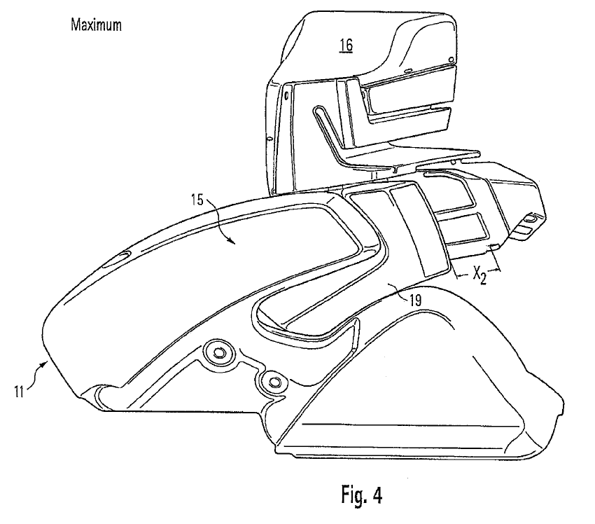

FIG. 4 is a view corresponding to FIG. 2, the catching element being in its forward-most position relative to the seat part (maximum depth and height of the catching element relative to the seat);

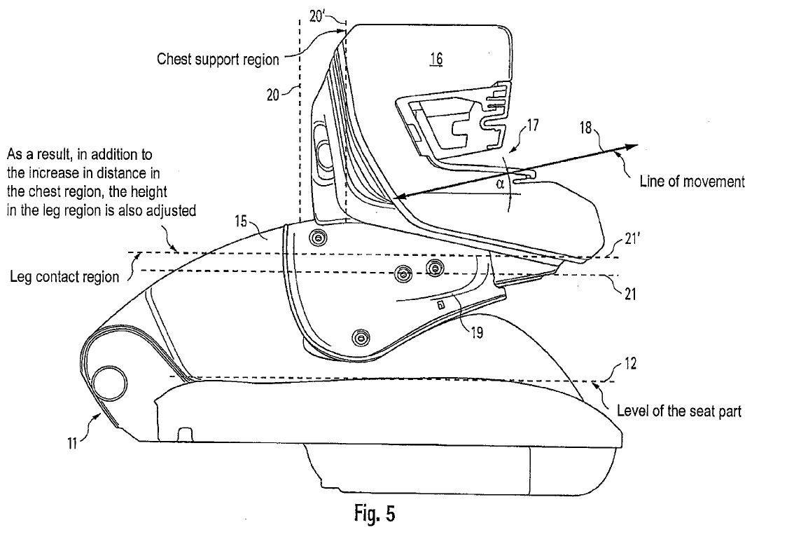

FIG. 5 is a view corresponding to FIG. 2 showing in diagrammatic form the movement of the catching element relative to the seat part;

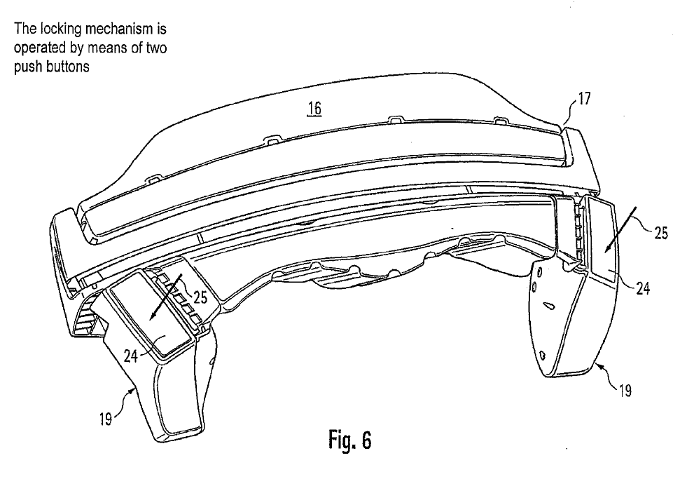

FIG. 6 is a perspective front view of the catching element;

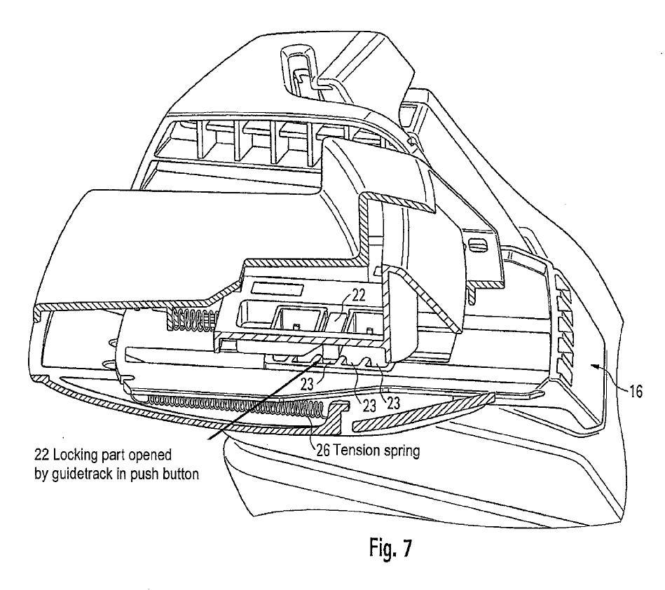

FIG. 7 is a perspective sectional view of the catching element, showing a locking mechanism in the opened state; and

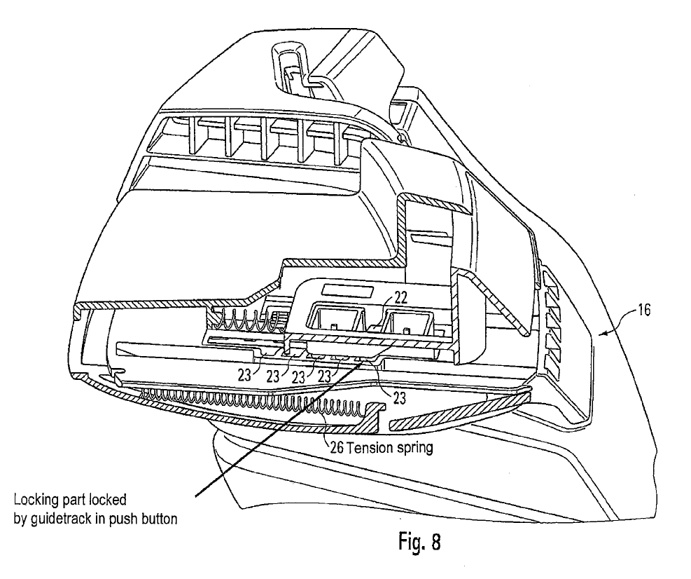

FIG. 8 is a view corresponding to FIG. 7 with the locking mechanism in the locked state.

FIG. 1 shows a child seat 10 which is intended for mounting on a vehicle seat, for example on the rear seat of a motor vehicle. The child seat comprises a seat part 11 having a seat surface 12, a backrest 13 having a headrest 14 and two armrests 15 which in the present case are joined integrally to the seat part 11. Furthermore, the child seat 10 is associated with a catching element 16 which, extending transversely above the thighs of a child sitting in the child seat, is mounted so as to be adjustable in the longitudinal direction of the armrests 15. On the front side of the crossbar-like catching element there is a slot-like opening 17 for receiving portions of a safety belt associated with a motor vehicle, especially a three-point safety belt. In this case both a horizontal portion and a diagonal portion of the safety belt extend through the slot-like opening 17. The child seat 10 is thus held on the vehicle seat by the safety belt.

The catching element 16 preferably comprises a hollow or foam body of approximately U-shaped cross-section which is open towards the front and defines the mentioned belt-receiver 17. On the side facing the child, that is to say both the side facing the backrest 13 and the side facing the seat surface 12, the catching element 16 is padded.

As already mentioned at the beginning, the catching element 16 can comprise elements that are plastically deformable under the action of impact forces, especially in the chest support region or in the region of attachment to the child seat, especially on both armrests 15 thereof. The safety-related aspect of this configuration has likewise been mentioned at the beginning.

FIG. 2 shows the seat part 11 only, without padding and covering, in side view. It can also be seen very clearly in FIG. 2 that the armrests 15 associated with the seat part 11 are joined integrally to the seat part. The catching element 16 is attached to the armrests 15 by means of a connecting part 19. The attachment of the catching element 16 to the connecting part 19 is effected in such a way that the catching element 16 is movable back and forth in the direction of the double-headed arrow 18. That relative movement can be seen by comparing FIG. 2 with FIGS. 3 and 4. In FIG. 2, the catching element 16 is in the rearmost position, that is to say in a position in which it is closest to both the backrest and the seat surface. In FIG. 3, the catching element 16 has been displaced forwards by a predetermined amount “X₁” and locked in that position. In FIG. 4, the catching element 16 is in the forwardmost position. The displacement path is labelled “X₂”.

In FIGS. 2 to 4, as well as in FIG. 5, it can be seen that the adjustment direction of the catching element 16 runs at an angle α, increasing from back to front, of greater than 0°, especially of about from 5° to 20°, relative to the seat surface 12 (see especially FIG. 5), which angle is either predetermined or arises freely. The catching element can thus be adapted in an optimum way to different body sizes of a child sitting in the child seat, both in the chest region and in the region of the child's thighs. In other words, according to the invention both the depth and the height of the catching element 16 can be adjusted, namely the depth relative to the chest and the height relative to the thighs of a child. In FIG. 5, two associated chest support regions on the one hand and leg contact regions on the other hand are indicated by reference numerals 20, 20′ and 21, 21′, respectively.

In the embodiment shown, the catching element 16 is arranged to be adjustable stepwise, the fixing of the position of the catching element 16 relative to the seat part and the backrest preferably being effected by an interlocking connection, more specifically by a locking mechanism arranged between the connecting part 19 and the catching element 16. In a preferred embodiment, that locking mechanism comprises at least two, but especially from four to eight, preferably at least five, locking positions. Accordingly, each connecting part 19 comprises a locking element, especially a bar-like locking element 22 (see FIGS. 7 and 8), which is engageable under resilient bias, that is to say under the resilient bias of, for example, a compression spring, in at least two, here five, locking recesses 23 spaced apart from one another on the catching element 16 in the adjustment direction thereof.

The locking elements 22 associated with each connecting part 19 are in operative connection with a push button 24 (see FIG. 6) accessible from the outside, the operation of which in the direction of the arrow 25 in FIG. 6 is arranged to move the locking elements 22, against their resilient bias, into the disengaged position, that is to say the catching-element-release position, as shown diagrammatically in FIG. 7. In that position the bar-like locking element 22 has been moved out of engagement with an associated locking recess 23.

In FIG. 8, however, the bar-like locking element 22 is in the locking position, that is to say inside one of the five locking recesses 23.

The operative connection between the push button 24 and the locking bar 22 is effected in a manner known per se, preferably by means of a guidetrack arrangement.

It should also be mentioned that the catching element 16 is adjustable or displaceable, against the action of a resilient element, especially a tension spring 26, out of the position in which it is nearest to the backrest 13 and the seat surface 12, into a position in which it is further away therefrom. The mentioned tension spring 26 is shown in FIGS. 7 and 8. That means that on operation of the push buttons 24 and unlocking of the locking elements 22, 23, the catching element 16 is moved back, more or less automatically, by the tension spring(s) 26 into a position corresponding to FIG. 2.

By means of the mentioned locking positions, a firm connection of the catching element relative to the seat is ensured in every locking position.

The seat part including the armrests 15 is a one-piece component made of plastics material covered with suitable padding. The backrest is formed or articulated on the seat part in a manner known per se.

All the features disclosed in the application documents are claimed as being important to the invention, provided they are novel over the prior art either individually or in combination.

### REFERENCE NUMERALS

10 child seat

11 seat part

12 seat surface

13 backrest

14 headrest

15 armrest

16 catching element

17 opening for receiving portions of the safety belt

18 double-headed arrow

19 connecting part

20, 20′ chest support region

21, 21′ leg contact region

22 locking element (locking bar)

23 locking recess

24 push button

25 arrow

26 tension spring

1. In a safety device for a child seat in a vehicle, having a seat surface, and backrest, which comprises at least one catching element that extends approximately transversely above the thighs of a child sitting in the child seat and is mounted so as to be adjustable in a direction approximately parallel to the seat surface, wherein the improvement comprises the adjustment direction of the catching element running at an angle (α), increasing from back to front of >0°, relative to the seat surface.

2. Safety device according to claim 1, in which the catching element is adjustable steplessly or stepwise.

3. Safety device according to claim 1, in which the relative position of the catching element is fixable by a force-based connection and/or by interlocking,

4. Safety device according to claim 3, in which the catching element is lockable to the child seat, especially to connecting parts joined to armrests, especially in the form of connecting cheeks, in at least two different positions relative to the seat surface and the backrest.

5. Safety device according to claim 4, in which the longitudinal guide means of the catching element comprises from four to eight locking positions

6. Safety device according to claim 4, in which each connecting part comprises a locking element which is engageable under resilient bias in at least two locking recesses spaced apart from one another on the catching element in the adjustment direction thereof.

7. Safety device according to claim 6, in which each locking element is in operative connection with a push button or like operating element which is accessible from the outside, the operation of which is arranged to move the locking element, against its resilient bias, into the disengaged position, that is to say the catching-element-release position

8. Safety device according to claim 1 in which the catching element is adjustable or displaceable, against the action of a resilient element out of the position in which it is nearest to the backrest and the seat surface, into a position in which it is further away therefrom.

9. Safety device according to claim 1, in which the catching element comprises padding facing the chest and optionally also the thighs of a child using the device, which padding defines a chest support region and a leg contact region.

10. Safety device according to claim 1, in which the catching element comprises elements that are plastically deformable under the action of impact forces, especially in the chest support region and/or in the region of attachment to the child seat, especially on the two armrests thereof.

11. Safety device according to claim 1, in which the catching element has on the side remote from the backrest an opening for receiving portions, especially a horizontal portion and a diagonal portion, of a safety belt associated with a motor vehicle, especially a three-point safety belt.

12. Safety device according to claim 1, in which the catching element comprises a hollow body of approximately U-shaped cross-section which in the mounted position is open towards the front and defines a slot-like belt-receiver.

13. Safety device according to claim 1 in which angle (α) is about from 5° to 20° relative to the seat surface.
